(19) United States
(12) Patent Application Publication
(10) Pub. No.: US 2015/0104034 A1
(43) Pub. Date: Apr. 16, 2015

(54) APPARATUS FOR TRANSFERRING PROGRAMMING DATA BETWEEN A DATA UPGRADE/TRANSFER UNIT AND A COMMUNICATIONS DEVICE THROUGH A SPEAKER MICROPHONE

(71) Applicant: William H. Jennings, Huddleston, VA (US)

(72) Inventor: William H. Jennings, Huddleston, VA (US)

(21) Appl. No.: 14/509,645

(22) Filed: Oct. 8, 2014

Related U.S. Application Data
(60) Provisional application No. 61/961,400, filed on Oct. 15, 2013.

(51) Int. Cl. H04R 1/10; H04R 1/06; H04R 1/08

(52) U.S. Cl. CPC H04R 1/1041; H04R 1/08; H04R 1/06
USPC 381/74; 381/122

(57) ABSTRACT

An apparatus is disclosed for transferring programming data between a data upgrade/transfer unit, such as a programmer and/or a keyloader, and a communications device. The programming data and/or keys may be routed through a speaker microphone or other device. The speaker microphone includes, or connects to, a cable that connects to a connector interface on the communications device. Additionally, a jack or port on the speaker microphone connects to the programmer/keyloader via a data transfer cable. Programming data can be transmitted through the speaker microphone between the programmer/keyloader and the communications device. The speaker microphone can operate normally with the communications device when the programmer/keyloader is not connected to the port. The port on the speaker microphone may be configured to also connect to an accessory device, such as a headset, to transmit other types of data between the accessory device and the communications device by passing through the speaker microphone.

### FIELD OF THE INVENTION

The present invention relates to an apparatus for transferring programming data between a data upgrade/transfer unit, such as a programmer and/or a keyloader, and a communications device, wherein the programming data and/or keys are routed through a speaker microphone, or other device. An accessory device may also be connected to the speaker microphone in place of the data upgrade/transfer unit for use with the communications device.

### BACKGROUND

Communications devices, such as radios and portable phones that receive (RX) and transmit (TX) audio, are commonly used in business, military, public safety, industrial, commercial, SWAT and personal applications, among others. These communications devices often require software, firmware, and/or encryption updates/upgrades before they can be fully utilized, i.e. after they have already been sold and/or deployed. Moreover, communications devices commonly make use of various accessories, which may include speaker microphones, data collectors and headsets, among others. Programming a communications device is usually performed using a computer, laptop, or other dedicated hardware/software that possesses the information to be transferred to the device.

Soldiers often use a speaker microphone that is attached to a radio through a connector/cable assembly. A conventional connector interface between the radio and the speaker microphone cable is the same interface used to connect a data upgrade/transfer cable so that a data upgrade/transfer unit can directly connect to the communications device. In order to establish a connection between the data upgrade/transfer unit and the radio, however, the speaker microphone cable must first be unplugged from the connector interface in order to accommodate the data upgrade/transfer cable, as illustrated in FIGS. 1 and 2. In other words, this arrangement requires the speaker microphone to be completely disconnected from the communications device so that the upgrade/transfer unit can access the connector interface on the radio.

For various reasons, it is not always feasible, safe or efficient to connect a cable directly between the communications device and the data upgrade/transfer unit, or even wirelessly link the communications device to the data upgrade/transfer unit. For example, it is very difficult and time consuming for a soldier in a combat situation using a PRC/MBITR series radio to use these conventional data transfer methods since the radio is very large and is often worn in a backpack that is not easily or quickly accessible to the soldier. It is also difficult for other soldiers to access the radio due to its location inside a backpack or other carrying case. Data transfer methods typically involve removing the radio from the user's pack in order to make it accessible to the data upgrade/transfer unit. This task requires at least two soldiers, which can be very dangerous and undesirable in a hostile situation. Thus, there exists a clear need to provide a way to easily, quickly and efficiently transmit data from a data upgrade/transfer unit to a communications device.

### SUMMARY

The present invention provides a method and apparatus for transferring programming data and/or keys between a data upgrade/transfer unit, such as a programmer and/or keyloader, and a communications device, such as a radio, wherein the programming data is routed through a speaker microphone, or other intermediate device. Such programming data may include, but is not limited to, software or EEPROM update data, keys, patches, authentication data, and/or encryption data. The speaker microphone includes, or is connected to, a cable that connects to a connector interface on the communications device. Additionally, a jack or port on the speaker microphone connects to one end of a data transfer cable, and the opposite end of the data transfer cable connects to the programmer/keyloader. Programming data can thus be transmitted through the speaker microphone between the programmer/keyloader and the communications device. The data upgrade/transfer operation of the present invention can advantageously be performed with ease by an individual user. Moreover, the data upgrade/transfer process can be performed faster and more efficiently than conventional data transfer techniques. Furthermore, the port on the speaker microphone may be configured to also connect to an accessory device, such as a headset unit, to transmit other types of data, such as analog data, between the headset and the communications device by passing through the speaker microphone.

For example, when a soldier uses the data transfer apparatus of the present invention, he would not have to unpack his radio, disconnect his accessory device and plug in the data upgrade/transfer unit, which limits the soldier's amount of movement, and thus possible exposure to hostile fire or loss of opportunity. The data transfer apparatus of the present invention may also allow the soldier to maintain radio communications through the speaker microphone while the data upgrade/transfer process occurs. This feature greatly enhances the safety and battlefield effectiveness of the soldier.

In the present invention, a speaker microphone is adapted to connect to a radio transceiver by a cable. The speaker microphone has a housing including an internal speaker and an internal microphone, and a port adapted to operatively couple a programmer/keyloader device to the speaker microphone. The speaker microphone also includes circuitry configured to receive programming data or keys from the programmer/keyloader device through the port, wherein the circuitry is further configured to provide the programming data or keys to the cable for transferring the programming data or keys between the programmer/keyloader device and the transceiver by routing through the speaker microphone. The port may be adapted to operatively couple an accessory device to the speaker microphone, wherein the accessory device is a headset unit including an external speaker and an external microphone. The speaker microphone may also include a bias voltage injector configured to supply bias voltage to the external microphone. Additionally, the speaker microphone may include a toggle button configured to switch between operating the speaker microphone or the programmer/keyloader device when the programmer/keyloader device is coupled to the port. Further, the speaker microphone may include a detecting circuit for detecting when the programmer/keyloader device is connected to the port.

In a variation of the present invention, a device is connectable to a transceiver through a cable. The device includes a housing having a port arranged to be operatively coupled to a programmer/keyloader for performing a data transfer function. The device also includes circuitry configured to receive programming data or keys from the programmer/keyloader through the port, wherein the circuitry is further configured to provide the programming data or keys to the cable for transferring the programming data or keys between the programmer/keyloader and the transceiver by routing through the device. The device is configured to perform the data transfer function when the programmer/keyloader is connected to the port. The device is further configured to perform an accessory function other than data transfer function when the programmer/keyloader is not connected to the port. The accessory function may be a speaker function and/or a microphone function. Moreover, the port is further adapted to operatively couple an accessory device to the housing. For example, the accessory device may be a headset unit including an external speaker and an external microphone.

In another variation of the present invention, a data transfer apparatus for a communications device includes a speaker microphone operatively coupled to the communications device. A data upgrade/transfer unit is operatively coupled to the speaker microphone and configured to transmit programming data to and from the communications device during a keyfill mode of operation, wherein the programming data passes through the speaker microphone. The speaker microphone may also comprise a toggle button adapted to switch between operating the speaker microphone and the data upgrade/transfer unit. An accessory device may be operatively coupled to the speaker microphone and configured to transmit analog data to and from the communications device, wherein the analog data passes through the speaker microphone. For example, the accessory device may be a headset unit comprising an external speaker and an external microphone, wherein the headset unit is configured to transmit audio data to and from the communications device such that the audio data passes through the speaker microphone. The speaker microphone further comprises a dual role port adapted to connect to the data upgrade/transfer unit and the accessory headset.

### BRIEF DESCRIPTION OF THE DRAWINGS

Various advantages, features and functions of an apparatus for transferring programming data will become readily apparent and better understood in view of the following description and accompanying drawings. The following description is not intended to limit the scope of the apparatus, but instead merely provides exemplary embodiments for ease of understanding.

FIG. 1 is a front elevation view of a communications device directly connected to a speaker microphone according to conventional practices.

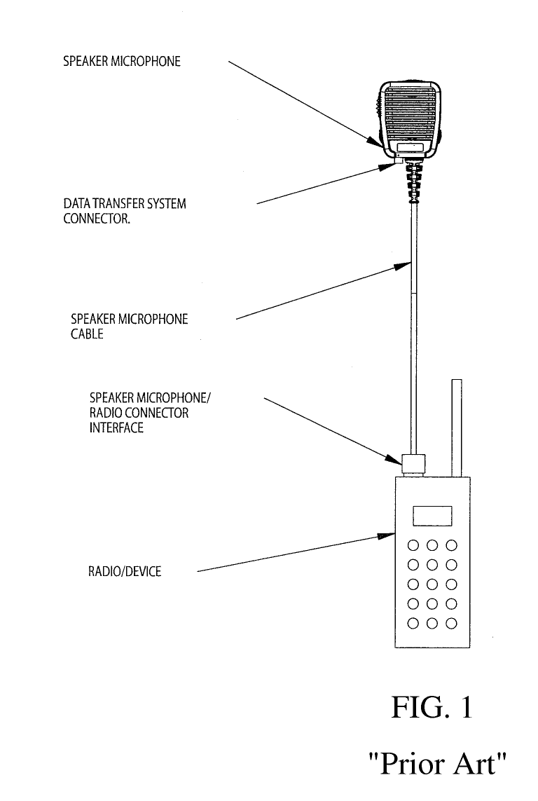

FIG. 2 is a front elevation view of the communications device of FIG. 1 directly connected to a data upgrade/transfer unit according to conventional practices, wherein the speaker microphone is entirely disconnected.

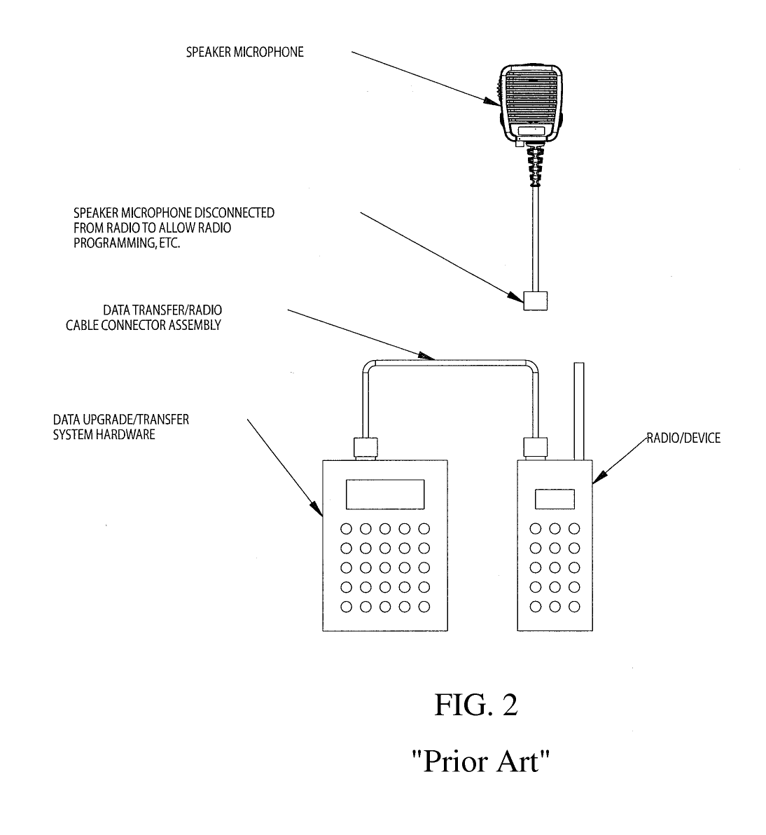

FIG. 3 is a front elevation view of the apparatus of the present invention according to a keyfill mode of operation.

FIG. 4 is a front elevation view of the apparatus of the present invention according to a normal mode of operation.

FIG. 5 is a functional block schematic drawing of the apparatus of the present invention according to the normal mode of operation.

FIG. 6 is a functional block schematic drawing of the apparatus of the present invention according to the keyfill mode of operation.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary configurations of a data transfer apparatus, and in no way limit the structures or configurations thereof according to the present disclosure.

### DETAILED DESCRIPTION

A better understanding of various embodiments of the invention may be had from the following description read in conjunction with the accompanying drawings. While the disclosure is susceptible to various modifications and alternative constructions, certain illustrative embodiments are shown in the drawings and are described below in detail. It should be understood, however, that there is no intention to limit the disclosure to the specific embodiments disclosed, but on the contrary, the intention is to cover all modifications, alternative constructions, combinations, and equivalents falling within the spirit and scope of the disclosure.

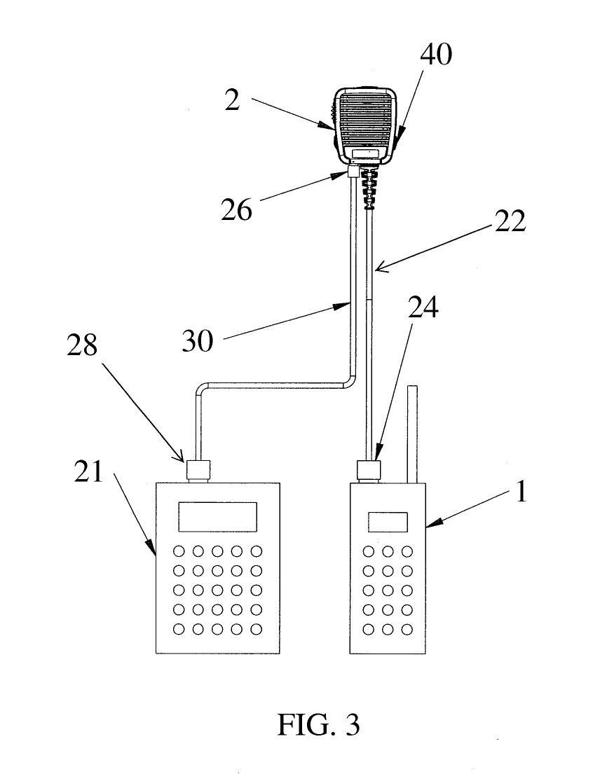

An apparatus for transferring programming data is shown in FIG. 3, wherein a communications device, such as a radio transceiver 1, is connected to a remote speaker microphone handset 2, or other types of devices configured to connect to a communications device. It should be appreciated, however, that many types of communications devices may be used, including land mobile radios, mesh network radios, trunked radio systems, cellular phones, WiFi network units, walkie talkies, and others. The speaker microphone 2 is further connected to a data upgrade/transfer unit, such as a pro grammer/keyloader 21. In particular, the data transfer apparatus of FIG. 3 is shown according to a keyfill mode of operation, wherein the programmer/keyloader 21 allows a user to program, configure and/or encrypt the communications device by transferring programming data or keys through the speaker microphone.

The speaker microphone 2 includes, or is connected to, a connection cable 22 that connects to a first connection interface 24 located on the transceiver 1. The speaker microphone further includes a jack or port 26 that connects to an end of a data transfer cable 30. The opposite end of the data transfer cable 30 connects to a second connection interface 28 located on the programmer/keyloader 21. Additionally, the data upgrade/transfer unit may also include a wireless device, such as a Bluetooth device, to wirelessly connect the speaker microphone to the programmer/keyloader. Programming data or keys transmitted between the programmer/keyloader 21 and the transceiver 1 is routed through the speaker microphone 2. Thus, the present invention advantageously allows a user to send and/or receive programming data between the data upgrade/transfer unit and the communications device without having to disconnect/remove the speaker microphone therefrom.

The speaker microphone 2 can be worn on a user's shoulder lapel so that it is quickly and easily accessible. The user can then connect the programmer/keyloader 21 directly to the speaker microphone 2 in order to transfer programming data through the speaker microphone to and from the radio 1. A toggle button 40 may also be provided on the speaker microphone 2 to let a user choose between operating either the speaker microphone or the programmer/keyloader when the programmer/keyloader is connected to the jack of the speaker microphone. The toggle button 40 thus allows a user to choose whether the programmer/keyloader or the speaker microphone works with the radio. The toggle button may comprise a mechanical, electrical or electro-mechanical switching mechanism that toggles functionality between operating either the speaker microphone or the programmer/keyloader. For example, the toggle button 40 may be a DPDT pushbutton switch. This switching mechanism enables the speaker microphone to receive and/or transmit audio and disable the data upgrade/transfer system, and vice versa, during a data transfer event. For instance, when the toggle button 40 is pressed, the link established between the programmer/keyloader and the radio overrides or bypasses the link between the speaker microphone and the radio so that only the programmer/keyloader can communicate with the radio.

A detecting circuit may also be included in the speaker microphone to detect when the programmer/keyloader is connected to the jack, such that a link between the programmer/keyloader and the radio may be automatically established upon detecting the presence of the programmer/keyloader. When the detecting circuit detects that the programmer/keyloader is unplugged from the speaker microphone, the link between the speaker microphone and the radio is reestablished so that the speaker microphone is enabled to receive and/or transmit audio with the radio.

In other embodiments, the user can maintain radio communications through the speaker microphone while the data upgrade/transfer process is carried out. For example, a multiplexer may be provided in the speaker microphone handset 2 to allow continuous use of the speaker microphone while the data upgrade/transfer between the data upgrade/transfer unit and the communications device continues to occur.

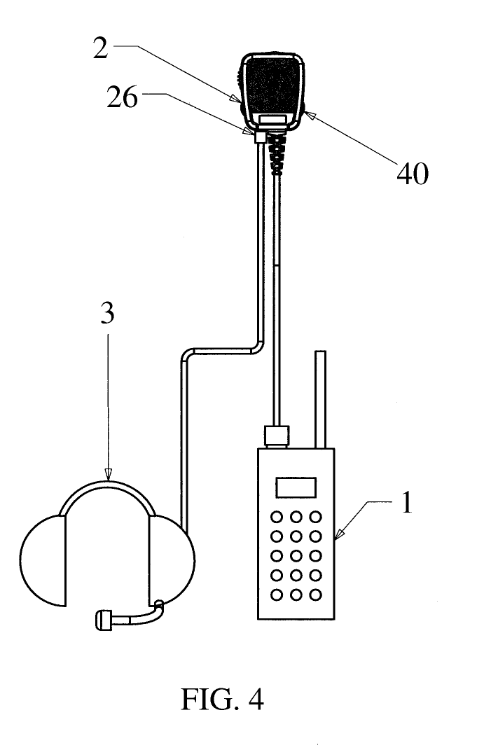

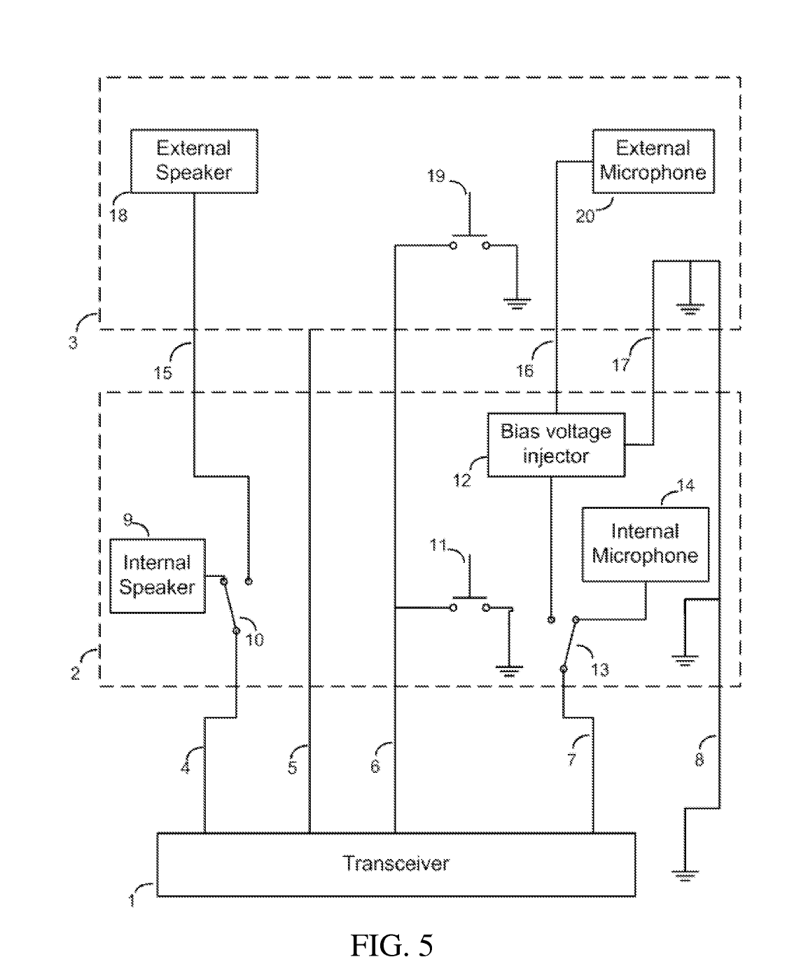

Furthermore, the jack or port 26 may further be employed in a dual role to also provide an interface for accessory devices, such as those which receive audio, receive/transmit audio, receive/transmit/PTT, as well as video devices, sensors and other accessories. Such accessory devices can be easily disengaged with the port 26 when a data upgrade/transfer operation must take place, and then re-engaged after it is completed. For example, FIG. 4 shows the data transfer apparatus of the present invention according to a normal mode of operation, and FIG. 5 shows a corresponding functional block schematic drawing of the data transfer apparatus of according to the normal mode of operation. During the normal mode of operation, the communications device is not actively updated by the programmer/keyloader. Thus, during the normal mode of operation, the accessory headset 3 operates normally with the speaker microphone and the communications device for transferring audio data. Moreover, the normal mode of operation also occurs when no accessory device is plugged into the port 26, such that the speaker microphone operates normally to transfer audio data with the communications device. In particular, a communications device, such as an MBITR radio transceiver 1, is connected to a remote speaker microphone 2 that includes an internal speaker 9 and an internal microphone 14. The speaker microphone 2 is adapted to connect to an accessory device, such as a headset 3 having an external speaker 18 and an external microphone 20. Other types of accessory devices may further include, but are not limited to, communications devices, data transmitters and various sensors, among others.

The speaker microphone includes circuitry that connects the port to the connection cable. A pair of internal switches, such as a speaker switch 10 and a microphone switch 13 are provided in a housing of the speaker microphone 2. The pair of internal switches 10, 13 may be jointly controlled by the toggle button 40 on the speaker microphone. It should also be appreciated that a detecting circuit may also be included in the speaker microphone to detect when the accessory headset 3 is connected to the speaker microphone in order to automatically toggle the switches 10, 13 to a position operatively coupling the headset to the transceiver.

The internal switches 10, 13 correspondingly operatively couple the internal speaker 9 and the internal microphone 14 to the transceiver when the speaker microphone is configured for use. For example, a first speaker line 4 transmits the receive (RX) audio data out to the internal speaker 9 from the transceiver, and a first microphone line 7 transmits the transmit (TX) audio data from the internal microphone to the transceiver. When the headset 3 is configured for use, the speaker switch 10 is triggered such that it operatively couples a second speaker line 15 into communication with the first speaker line 4 in order to transmit RX audio data out to the external speaker 18 from the transceiver. Similarly, when the headset 3 is configured for use, the microphone switch 13 is triggered such that it operatively couples a second microphone line 16 into communication with the first microphone line 7 in order to transmit TX audio data from the external microphone 20 to the transceiver.

A pair of auxiliary lines 5, 6 further connect the transceiver to the accessory headset 3. During this normal mode of operation, the first auxiliary line 5 is unused and the second auxiliary line is configured to 6 transmit a push-to-talk (PTT) input signal from either the headset or the speaker microphone to the transceiver. For example, the speaker microphone 2 includes a normally open PTT switch 11 operatively coupled to the transceiver via the second auxiliary line in order to activate the internal microphone 14. Similarly, the headset may include an auxiliary PTT switch 19 operatively coupled to the transceiver via the second auxiliary line 6 in order to activate the external microphone 20.

A ground line 8 electrically grounds the speaker microphone and the accessory headset 3. Further, a control input 17 connects the ground line 8 to a bias voltage injector 12 that is located in the speaker microphone housing. As a result, the bias voltage injector 12 is enabled to supply the required bias voltage needed by the external microphone 20. All of the lines that connect the accessory headset to the speaker microphone are accessed via the same jack or port 26 on the speaker microphone.

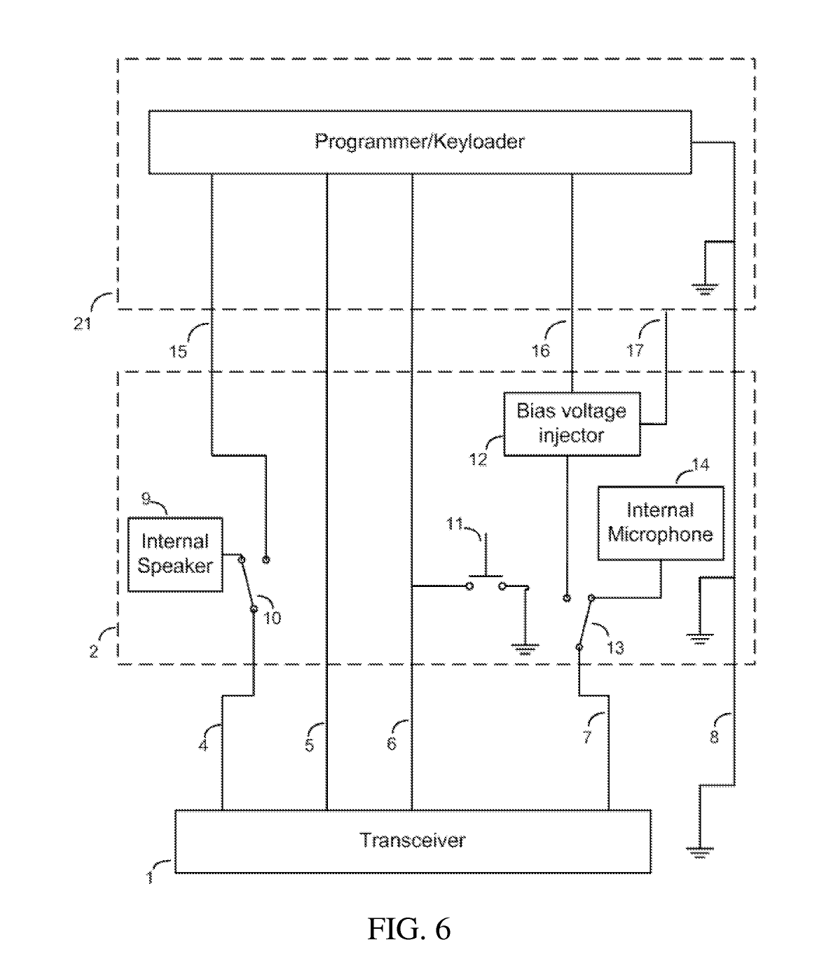

Referring to FIG. 6, a functional block schematic drawing of the data transfer apparatus is shown according to the keyfill mode of operation illustrated in FIG. 3, wherein the speaker microphone 2 is connected to a programmer/keyloader 21. In particular, the programmer/keyloader 21 is connected to the MBITR radio transceiver 1 through the port 26 on the remote speaker microphone 2. The bias voltage injector 12 disconnects the bias voltage when the data transfer cable 30 attaches the programmer/keyloader to the jack. Since the programmer/keyloader does not include an external microphone, there is no microphone bias voltage required, and its presence would be disruptive. Moreover, since the programmer/keyloader does not ground the control input 17 of the bias voltage injector 12, no bias voltage is supplied in this configuration. It should be appreciated, however, that the system may employ additional adaptive circuits as needed to accommodate other types of devices that utilize the jack.

In this keyfill mode of operation, the data interface between the transceiver 1 and the programmer/keyloader 21 comprises two serial data transmission lines (one line for each direction) and two handshaking lines (one line for each direction). The exchange of programming data, for either programming of operational frequencies or for cryptographic keyloading, may be instigated and controlled from the programmer/keyloader and not from the transceiver. For example, on public safety radios this process includes not only downloading lists of operational frequencies and cryptographic keys, but also downloading revised operational firmware. These exchanges are bi-directional to allow the programmer/keyloader to confirm that the download is free of errors. Additionally, the programming data may include various types of data formats or content and may be varied according to the requirements of the programmer/keyloader and the transceiver.

In particular, the first and second speaker lines 4, 15 are configured to transmit a ready to send (RTS) flow control signal, and the first auxiliary line 5 is configured to transmit a clear to send (CTS) flow control signal. The RTS and CTS signals are used to throttle data transmissions in both directions between the transceiver and the programmer/keyloader in order to avoid overrunning the receivers' buffers. Furthermore, in this keyfill mode of operation, the second auxiliary line 6 is configured to input RX programming data to the transceiver from the programmer/keyloader, and the first and second microphone lines 7, 16 are configured to output TX programming data from the transceiver to the programmer/keyloader.

The data transmitted from the transceiver to the programmer/keyloader may include acknowledgements of blocks of data received by the transceiver, and entire blocks of data are transmitted back to the programmer/keyloader for verification purposes. Authentication is also possible when the transceiver sends a challenge command to the keyloader, such that the keyloader prepares a response based on the challenge that proves itself to be an authentic keyloader.

Since the present invention has been disclosed in the context of certain exemplary embodiments, it therefore will be understood by those skilled in the art that the present invention extends beyond the specifically disclosed embodiments to other alternative embodiments, combinations of embodiments, and/or uses of the invention and modifications and equivalents thereof. Thus, it is intended that the scope of the present invention herein disclosed should not be limited by the particular disclosed embodiments described above.

What is claimed is:

1. A speaker microphone adapted to connect to a radio transceiver by a cable, the speaker microphone comprising:
a housing including an internal speaker and an internal microphone;
a port adapted to operatively couple a programmer/keyloader device to the speaker microphone; and
circuitry configured to receive programming data or keys from the programmer/keyloader device through the port, wherein the circuitry is further configured to provide the programming data or keys to the cable for transferring the programming data or keys between the programmer/keyloader device and the transceiver by routing through the speaker microphone.

2. The speaker microphone of claim 1, wherein the port is further adapted to operatively couple an accessory device to the speaker microphone.

3. The speaker microphone of claim 2, wherein the accessory device is a headset unit including an external speaker and an external microphone.

4. The speaker microphone of claim 2, wherein the accessory device is a video unit, sensor or other accessory.

5. The speaker microphone of claim 1, further comprising a toggle button configured to switch between operating the speaker microphone or the programmer/keyloader device when the programmer/keyloader device is coupled to the port.

6. The speaker microphone of claim 5, wherein the toggle button is a DPDT pushbutton switch.

7. The speaker microphone of claim 1, further comprising a detecting circuit for detecting when the programmer/keyloader device is connected to the port.

8. The speaker microphone of claim 1, further comprising a push-to-talk switch.

9. A device connectable to a transceiver through a cable comprising:
a housing having a port arranged to be operatively coupled to a programmer/keyloader for performing a data transfer function;
circuitry configured to receive programming data or keys from the programmer/keyloader through the port, wherein the circuitry is further configured to provide the programming data or keys to the cable for transferring the programming data or keys between the programmer/keyloader and the transceiver by routing through the device;
wherein the device is configured to perform the data transfer function when the programmer/keyloader is connected to the port, and wherein the device is further configured to perform an accessory function other than data transfer function when the programmer/keyloader is not connected to the port.

10. The device according to claim 9, wherein the accessory function is a speaker function and/or a microphone function.

11. The device according to claim 9, wherein the port is further adapted to operatively couple an accessory device to the housing.

12. The device according to claim 11, wherein the accessory device is a headset unit including an external speaker and an external microphone.

13. The device according to claim 9, further comprising a toggle button configured to enable the programming data or keys to pass through the housing between the programmer/keyloader and the transceiver when the programmer/keyloader is connected to the port.

14. A data transfer apparatus for a communications device, said apparatus comprising:
a speaker microphone operatively coupled to the communications device;
a data upgrade/transfer unit operatively coupled to the speaker microphone and configured to transmit programming data to and from the communications device during a keyfill mode of operation, wherein the programming data passes through the speaker microphone.

15. The data transfer apparatus of claim 14, further comprising an accessory device operatively coupled to the speaker microphone and configured to transmit analog data to and from the communications device, wherein the analog data passes through the speaker microphone.

16. The data transfer apparatus of claim 15, wherein the accessory device is a headset unit comprising an external speaker and an external microphone, and wherein the headset unit is configured to transmit audio data to and from the communications device such that the audio data passes through the speaker microphone.

17. The data transfer apparatus of claim 16, wherein the speaker microphone further comprises a toggle button adapted to switch between operating the speaker microphone and the data upgrade/transfer unit.

18. The data transfer apparatus of claim 14, wherein the data upgrade/transfer unit is a programmer/keyloader.

19. The data transfer apparatus of claim 14, wherein the communications device is a radio transceiver.

20. The data transfer apparatus of claim 15, wherein the speaker microphone further comprises a dual role port adapted to connect to the data upgrade/transfer unit and the accessory headset.
